(19) United States
(12) Patent Application Publication
(10) Pub. No.: US 2012/0023012 A1
(43) Pub. Date: Jan. 26, 2012

(54) System and Method for Registering an EDI Participant Identifier and Managing EDI Trading Partners

(76) Inventor: Alain Brousseau, Blainville (CA)

(21) Appl. No.: 13/188,807

(22) Filed: Jul. 22, 2011

Related U.S. Application Data
(60) Provisional application No. 61/367,076, filed on Jul. 23, 2010.

(51) Int. Cl. G06F 17/30; G06Q 40/00; G06F 15/16; G06F 7/00

(52) U.S. Cl. 705/39; 707/766; 707/805; 709/217; 707/754; 707/E17.005; 707/E17.014; 707/E17.059

(57) ABSTRACT

An EDI (Electronic Data Interchange) participant registry system provides a database connected to a computer network which permits access to an authoritative repository of records relating to the EDI communication. Participant may subscribe to publish their EDI related information's to existing or potential trading partners. The system provides participant with an interface so that each participant can subscribe and maintain is information as well as build is own trading partner list using other participant records. As all participant are responsible to maintain there information on the system, the trading partner list provides continuously valid data to facilitate business-to-business EDI communication.

### CROSS-REFERENCE TO RELATED APPLICATIONS

The present patent application claims the benefits of priority of U.S. Provisional Patent Application No. 61/367,076, entitled “EDI participant registry system” and filed at the United States Patent and Trademark Office on Jul. 23, 2010, the content of which is incorporated herein by reference.

### FIELD OF THE INVENTION

The present invention relates to the field of registry system for maintaining authoritative data on Electronic Data Interchange (“EDI”) participant(s), and more particularly to the field of efficiently managing EDI trading partners.

### BACKGROUND OF THE INVENTION

The availability and the precision of the information are key assets of success in the today's commerce business. The Electronic Data Interchange (EDI) communication is an electronic communication protocol for trading partners to communicate and interact with each other. Within the EDI communication, every participant or trading partner uses an identifier that must be unique to allow the routing of EDI documents. An EDI participant may define a custom identifier. However, the customer identifier must respect the rules of the related establish standard, especially for length limited and allowed characters. Conflicts may occur when two or more EDI participants are using an identical EDI identifier. In the event of an identifier conflict, an EDI participant may receive a wrongly addressed document. During such an event, an EDI participant may be unable to redirect the document as the identifier may be unknown or be assigned to more than one participant. Consequently, the legitimate owner of the document may never receive such document which, in this event, may remain lost and undelivered to is legitimate recipient. As a consequence, one or more participant may incur important or even tremendous damages due to the lost of the content of the wrongly addressed document. In addition to the damages, a time consuming retrieving procedure might be required in order to find the lost document. In fact, since no directory exists, it might be impossible to find the destination of the document and recover the said document.

Actually, an EDI participant has no mean to verify the availability of an EDI identifier. Also, any EDI participant may interact with thousands of trading partners, consequently, the task to maintain a trading partner list may require a tremendous amount of work. As an example, in the event where the EDI coordinator contact information is replaced or changed, such changes may have to be propagated to thousands of trading partners, a process that may be prone to errors. Therefore, there is a need for a uniform, independent, unique and central EDI participant registry that maintains EDI related information and that enables the different trading partners to access this useful information.

### SUMMARY OF THE INVENTION

The present invention discloses a system for maintaining a central, unique, uniform, secure, and neutral source of EDI participant information that prevents EDI identifier conflicts and that effectively manages the different trading partners.

The aforesaid and other objectives of the present invention are realized by generally providing an EDI participant registry system for providing a central, unique, uniform, secure and neutral source of EDI participant related information and capabilities, and providing a self-maintainable trading partner list.

The architecture for the system provides an environment to support processes that are used to collect and maintain information among system subscribers, herein referred as EDI participant. Within the scope of this document, an EDI participant may represent an EDI identifier subscriber. Also, an EDI identifier represents a sequence of characters, such as alphanumerical or numerical characters, for which the maximum length varies following the different association industry standards definitions. Within the scope of this invention, an EDI identifier uniquely identifies an EDI participant. A user of the system in accordance with the present invention may or may not be an EDI identifier subscriber. In fact, an EDI participant is always linked to a user and an EDI identifier is always linked to an EDI participant. However, a user of the system may not be linked to an EDI participant. Also, a user of the system may or may not be a human being as any automated external system may also communicate with the provided system. An EDI participant may also establish and manage a list of other related EDI participants, herein referred to as trading partners. Within the scope of this document a trading partner may be represented as a supplier, a client or any other EDI participant.

The system comprises at least one registry data storage, an XML file or any type of storage system, at least one registry server, at least one network and the graphical user interface of a client device. The system may be accessed through the graphical user interface of the client device or through any automated communication mean such as API, web services and remote procedure calls. Within the scope of this document, the usage of the terms graphical user interface includes the access through an automated communication mean.

The present invention also discloses various methods for searching an assigned EDI identifier, for registering an unassigned EDI identifier for an authenticated and an unauthenticated user, for adding a trading partner to an authorized trading partner list, for a user to communicate with at least one trading partner, for communicating with another system, and for updating EDI profile information using the aforesaid described system.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is an architectural diagram of an EDI participant registry system in accordance with the principles of the present invention.

FIG. 2 is a workflow diagram of a method to search an EDI identifier.

FIG. 3 is a workflow diagram of a process of registration of a new EDI identifier for an authenticated user.

FIG. 4 is a workflow diagram of a method to create a new user account prior the registration of a new EDI identifier by an unauthenticated user. Within this figure, the anchor A is linked to FIG. 3.

FIG. 5 is a workflow diagram of a process to add a trading partner to the authorized trading partner list.

FIG. 6 is a workflow diagram of a process to filter and search trading partners within the authorized trading partners list.

FIG. 7 is a workflow diagram of a process of communication with trading partners.

FIG. 8 is a workflow diagram describing the process of the update of an EDI profile.

### DETAILED DESCRIPTION OF THE PREFERRED EMBODIMENT

A novel EDI participant registry system and various related methods will be described hereinafter. Although the invention is described in terms of specific illustrative embodiments, it is to be understood that the embodiments described herein are by way of example only and that the scope of the invention is not intended to be limited thereby.

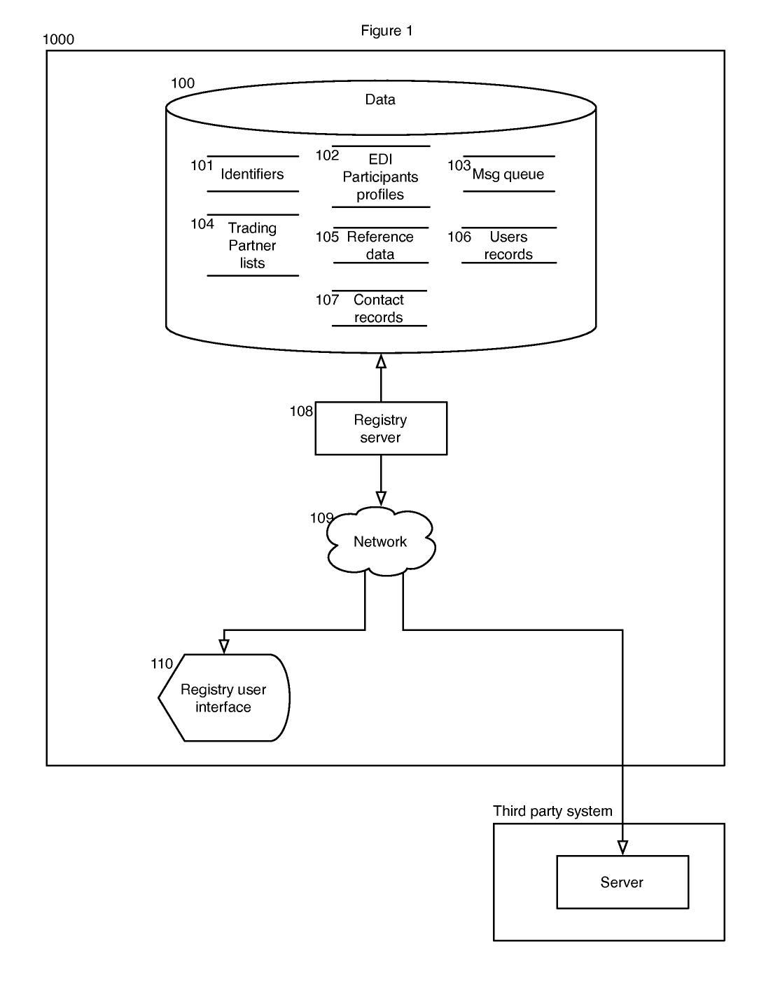

Referring to FIG. 1, the architecture of the system for registering an EDI participant identifier is shown. The architecture for the system provides an environment to support processes used to collect and maintain information among EDI participant. The system also provides an EDI participant the capabilities to build a list of trading partners. The system 1000 comprises at least one registry data storage 100, such as a database, an XML file or any type of storage system, at least one registry server 108, at least one network 109 and a client device 110. The registry data source comprises information data to be exchanged among users belonging to an EDI community, such as the profile data of every EDI participant 102, the EDI identifiers data 101, at least one message list 103, at least one trading partner list 104, reference data 105, EDI participant user data 106 and contact data 107. The profile data of an EDI participant 102 comprises information related to the identities of the EDI participant and to subscription details of the participant. The EDI identifiers data 101 comprises a unique EDI identifier within the system and may comprise the EDI information from the reference data 105. The contact data 107 may comprise the coordinates of an EDI participant and of a technical resource of the EDI participant. The coordinates may comprise information such as the address information, the email addresses and the telephone numbers, and a technical person. The EDI participant user data 106 comprises the registered user details, such as a unique user identifier, a password and any user related data. The EDI participant may be associated to more than one user. The trading partner list 104 represents the links between at least two EDI participants that are using EDI as a communication mean. The message list comprises notifications exchanged between trading partners. The reference data 105 defines the different requirements of the data content of the registry data source 100, such as metadata, data source 100 configuration data and other data related to the content of the registry data source 100.

In another embodiment, the at least one server and the at least one storage service may be installed on the same physical machine.

A client device 110 having a device to connect to a network 109 and having a display mean, such as a laptop or desktop computer, a smart phone, a netbook, a net tablet or any other network device, may be used to connect to the system 1000 through a network 109, such as a wide area network, the Internet or a local area network. Once the client device 110 is connected to the system 1000, a user may realize any method or a subset of the methods herein described in accordance to the present invention through a graphical user interface, such as a web-based interface, a native interface or a smart phone application, that is displayed on the client device 110.

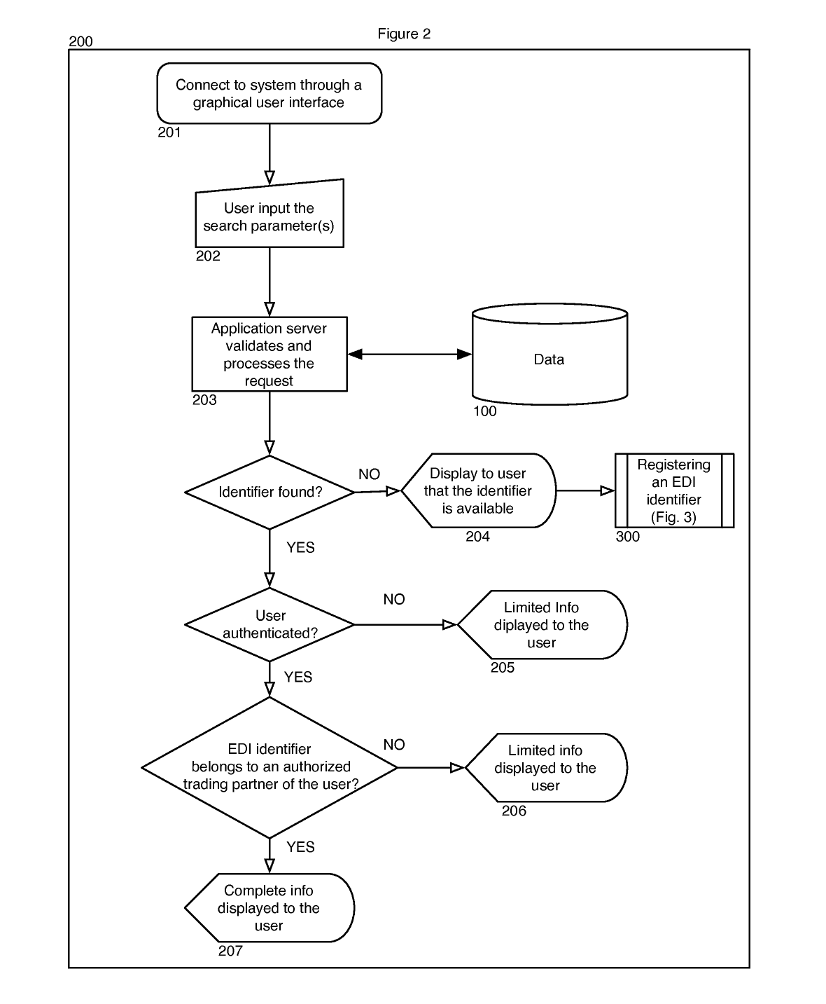

Now referring to FIGS. 2 to 8, methods for using an EDI participant registry system and managing EDI trading partners in accordance with the present invention are shown.

Referring to FIG. 2, a method to search for an EDI identifier is presented 200, the method comprising the steps to connect to the system 201, to input at least one identifier search parameter 202, to validate the at least one identifier search parameter 203, to display one or more unassigned identifier that is available for registration 204, to display the resulting identifiers 205, 206 and 207. The step to connect to the system 201 allows a user to access the system through the graphical user interface of a client device 110. The connection to the system may be realized through an HTTP request or any request based on a network protocol.

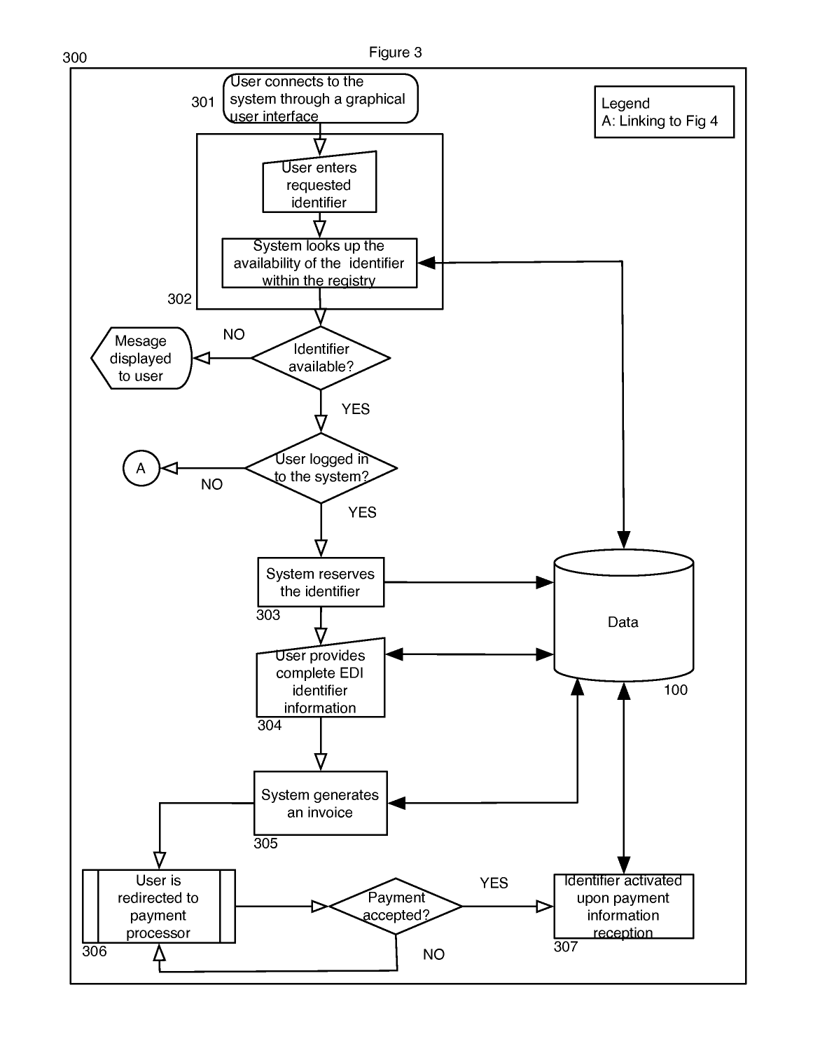

Once connected, a user may input through the graphical user interface at least one parameter 202, such as a part or the full sequence of the EDI identifier, of the owner of the EDI identifier or of any other parameter relevant to seeking an EDI identifier. The at least one input parameter is submitted to the system 203. During the submission step 203, the system may validate the at least one parameter using validation rules such as, but not limited to, looking for wildcard character or code injection in order to prevent malicious retrieval of a portion or of the totality of the content of the registry, looking for non alphanumerical characters within the inputted parameter or any other validation rules related to limiting or increasing the odds to obtain valid results while fetching the registry data source 100. Then, on validation of the at least one input parameter, the system accesses the registry data source 100 and fetches the EDI identifiers matching to the at least one input parameter. In the present embodiment, when a user has inputted at least one parameter a comprising a complete sequence of an existing EDI identifier, the system will only fetches the exact matching EDI identifier from the registry data source. Such exact matching process may not consider the capitalization of the EDI identifier. If no matching EDI identifier is found within the registry data source, a user may request the registration of the at least one EDI identifier exactly matching the at least one inputted parameter, such process being hereafter described in FIG. 3.

Following the fetching of the EDI identifiers, if at least one matching identifier is fetched, the system displays the complete or partial matching identifier information 204 to the graphical user interface of the client device. In the present embodiment, the system displays different information based on the status of the user. A user may be assigned the statuses “not authenticated”, “authenticated” and “trading partner”. If the user is associated with a “not authenticated” status, the system displays partial information related to the matching identifiers 205, such as the owner name, the qualifier or the expiration date. If the user has an “authenticated” status, in addition to the partial information displayed to the user having a “not authenticated” status, the system displays the partial information related to the matching identifier 206, such as a communication mean and a supported transaction set. If the user has a “trading partner” status, the system displays the complete information related to the matching identifier 207.

In another embodiment, the system may display complete or partial information based on any status of the user.

Now referring to FIG. 3, a method to register an unassigned EDI identifier is presented 300. An unassigned EDI identifier relates to an EDI identifier that is not present within the registry data source or that is inactive. An EDI identifier may be inactive if the owner has abandoned the identifier or has failed to pay for the registration fees. The method for registering an unassigned EDI identifier may comprise the steps to access the system through an interface 301, to search for an unassigned EDI identifier 302, to temporarily reserve the unassigned identifier 303, to request the registration of the unassigned EDI identifier 304, to generate invoicing information 305, to allow payment for the registration 306 and to activate the newly assigned EDI identifier 307.

The step to connect to the system 301 allows a user to access the system through the graphical user interface of a client device 110. The connection to the system may be realized through an HTTP request or any request based on a network protocol.

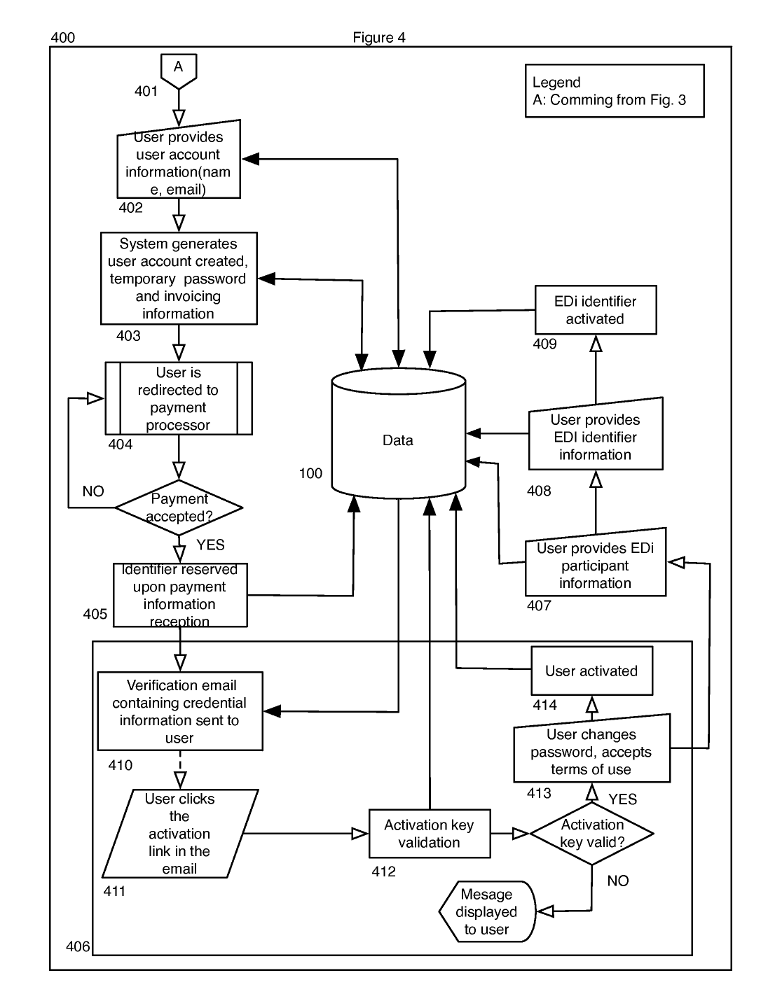

If the user is not authenticated to the system, the system may require the creation of an EDI participant account. During such an event, a user inputs the required account information, request the creation of the account and validate the account by activating the newly created account. Upon activation of the account, the system activates the newly registered EDI identifier, as per the method 400 described in FIG. 4.

If the user is authenticated, as described by method 300, the system displays a graphical user interface allowing to search for an unassigned EDI identifier 303. To search for unassigned EDI identifier, a user may input a complete EDI identifier into the system. Using the inputted complete EDI identifier, the system fetches for matching EDI identifier within the data source. If the EDI identifier is already assigned, the user is notified that the EDI identifier was previously assigned. The system may also suggest unassigned EDI identifiers that are orthographically similar.

If no matching EDI identifier is found by the system, the system temporarily reserves the unassigned EDI identifier 303. To complete this step, the system creates a new record within EDI identifier data of the data source. The new record is identified as a temporarily reserved identifier.

The step to request the registration of the unassigned EDI identifier 304 may require the user to input the complete EDI identifier information. The information to be inputted by the user may comprise, but is not limited to, the related qualifier, communication method, such as mail, electronic or telephone, and the supported transaction set. The system may provide a graphical user interface to submit the request to register an unassigned EDI identifier.

After submitting the request to register an unassigned EDI identifier, the system may automatically generates the invoicing information from the user profile data 305. Then, the system electronically displays the generated invoicing information through the graphical user interface. The generated invoicing information may comprise all information related to the EDI identifier to be assigned, such as the duration of reservation, the EDI participant, the billing information or any EDI identifier related information.

On consultation of the generated invoicing information, the system redirects the client device to a payment processor system 306. The payment processor system requires the user to enter the information required to pay for the reservation, such as an account number, credit card information or any banking information. The payment processor system may be provided by a third party or may be embodied within the system.

On completion of the payment, the system activates the EDI identifier 307 by linking the EDI identifier to the EDI participant linked to the authenticated user. The created link is stored in the registry data source by the system.

Now referring to FIGS. 4, the method to register an EDI identifier for an unauthenticated EDI participant may comprise steps to search for an unassigned EDI identifier 401, to request the creation of a new user account in order to register the unassigned EDI identifier 402, to create a user profile account 403, to generate invoicing information 403, to allow payment for the registration 404, to reserve the newly assigned EDI identifier 405, to activate the user profile account using activation and verification method 406, to provide the new EDI participant related information 407 and to activate the EDI identifier 408.

To allow a user to search for an unassigned EDI identifier, the system displays a graphical user interface allowing searching for an unassigned EDI identifier 401, such step being presented as the step 301 of the method 300 that is presented in FIG. 3. To search for unassigned EDI identifier, a user may input a partial or a complete EDI identifier into the system. Using the inputted partial or complete EDI identifier, the system fetches for the matching EDI identifiers within the data source, such step being presented as the step 302 of the method 300 that is presented in FIG. 3. If the EDI identifier is already assigned, the user is notified that the EDI identifier was previously assigned. The system may also suggest unassigned EDI identifiers that are orthographically similar.

In the event where no matching EDI identifier is found by system, an unauthenticated user may request the registration of an account in order to register the matching unassigned EDI identifier, as per anchor A of FIG. 3, which link to anchor A of FIG. 4. The information to be inputted by the user shall include user profile account information such as the user's name, an electronic communication identifier, such as an email address, a social network identifier or an open identifier, and any other required credential information 402. On submission of the account information, the system creates a user profile account 403. During the creation of the user account, the system may assign a temporary password.

The system generates invoicing information 403 related to the registration of the unassigned EDI identifier substantially as herein above described for the step 305 of FIG. 3. On consultation of the generated invoicing information, the user is required to pay for the registration of the EDI identifier 404 substantially as herein above described for the step 306 of FIG. 3. Upon reception of the confirmation of the payment, the system reserves the newly assigned EDI identifier 405 substantially as described for step 303 of FIG. 3.

An activation and verification method 406 must be completed by the user to confirm the registration of the newly created user account. The system creates an activation key that is stored within the data source, an electronic validation notification comprising the user credential information, the activation key and at least one activation link, such as an URL 410. The validation notification is sent by the system to the electronic communication identifier related to the newly created user profile account 410. On reception of the validation notification, the user shall confirm that the electronic communication identifier is valid by clicking on the activation link 411. The system fetches the validation key within the data source and validates the user profile account 412. The system may request the user to input a different password and to accept terms and conditions of the system 413. On completion of these steps, the new user profile account is activated by the system 414.

The user must inputs the EDI participant related information, such as the coordinates, telephone number, web site, the technical contact information 407. The steps to provide EDI identifier related information 408 and to activate the EDI identifier 409 are substantially as described for steps 304 and 307.

In another embodiment, the generated invoicing information 305 and 403 may be sent to the user through any communication mean such as an email, an SMS, a facsimile or any other electronic communication mean, or may be manually sent to the user by a traditional communication mean such as postal services. In such another embodiment, the user may provide payment through traditional mean such as posting a check or calling a customer service representative with credit card information. On reception of the payment information, a customer service representative shall manually update the system with the payment information. Only then, the EDI identifier would be activated 307 for an authenticated user or may require the creation of a account for an unauthenticated user, as described by step 406.

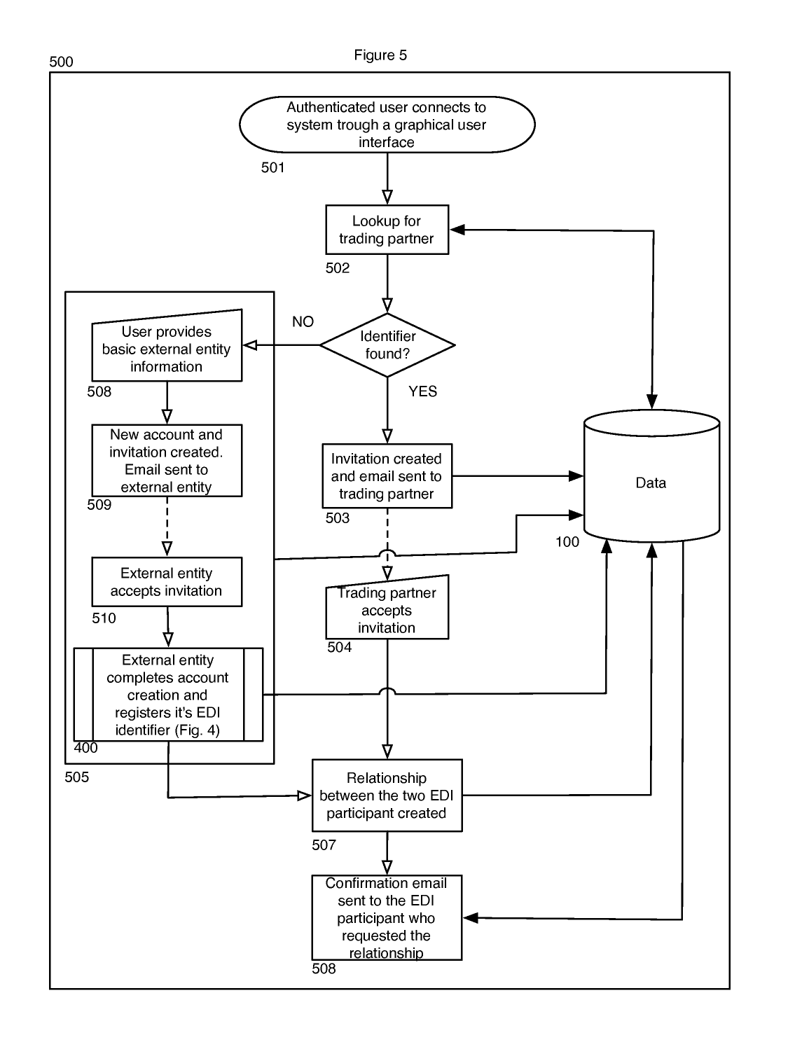

Now referring to FIG. 5, a method for adding a trading partner to an authorized trading partner list is presented 500. This method allows an EDI participant a right to access the complete or partial information of other related EDI participants, hereafter trading partners, and/or a right to communicate with them. The method for adding a trading partner may comprise steps to connect and authenticate with the system 501, to search for a trading partner 502, to send an invitation notification to a trading partner that is an EDI participant within the system 503, to invite an external entity, such as a company or any other organization using EDI as a communication mean, that is not already existing in the system to gain the status of an EDI participant within the system 505, to accept the invitation 505 and 506, to store the relationship information within the data source 507 and to confirm the relationship creation to the initiating EDI participant 508.

Similarly to step 201 presented in FIG. 2, the client device must connect to the system 501 to add a trading partner. The system requires the user to input his credential information in order to gain the authenticated status 501. Following the authentication of the user 501, the step to search for a trading partner may be executed 502. In order to search for a trading partner the user must input at least one filtering parameter, such as the name of the trading partner, the EDI identifier of the trading partner or any other parameter characterizing a trading partner. On submission of the at least one filtering parameter, the system fetches the data source for trading partner matching the at least one filtering parameter.

In the event where the system finds at least one matching trading partner, the system creates and stores invitation data within the data source and communicates an invitation notification, such as an email, to the trading partner associated with the at least one matching parameter 503. Following the reception of the invitation notification, the trading partner may accept the invitation to be added to the authorized trading partner list of the inviting EDI participant. Such acceptation process may add the inviting EDI participant as an authorized trading partner of the invited EDI participant 504. The acceptation may be completed by clicking on an activation link or by any other confirmation mean, such as confirming the invitation through a web-based graphical user interface.

In the event where no matching trading partner has been found by the system while searching for trading partner 502, the inviting EDI participant may invite the external entity to gain the status of an EDI participant within the system 505. To create an invitation, the inviting EDI participant user must input basic external entity information, such as the name, email or address, through the graphical user interface 508. On submission of the external entity information, the system creates a new EDI participant account for the invited external entity and stores the account within the data source 509. The account may be stored as a temporary account. Simultaneously or sequentially to the creation of the account, the system creates and stores invitation data within the data source and communicates an invitation notification, such as an email, to the invited external entity 509. Following the reception of the invitation notification, the external entity may accept the invitation 510 to complete the creation of the account, herein referring to FIG. 4. The acceptation may be completed by clicking on an activation link or by any other confirmation mean, such as confirming the invitation through a web-based graphical user interface. The external entity may complete the EDI participant account registration and register the at least one EDI identifier information details, such as the unique EDI identifier string. The relationships will be stored in the EDI registry data source upon payment of the at least one EDI identifier requested by the EDI participant 507.

Following the acceptation of the existing invited trading partner, the system creates and stores the relationship information within the data source 507. The newly created relationship is confirmed to the initiating EDI participant 508 by sending a confirmation notification through any electronic communication mean, such as an email, a system communication or an SMS.

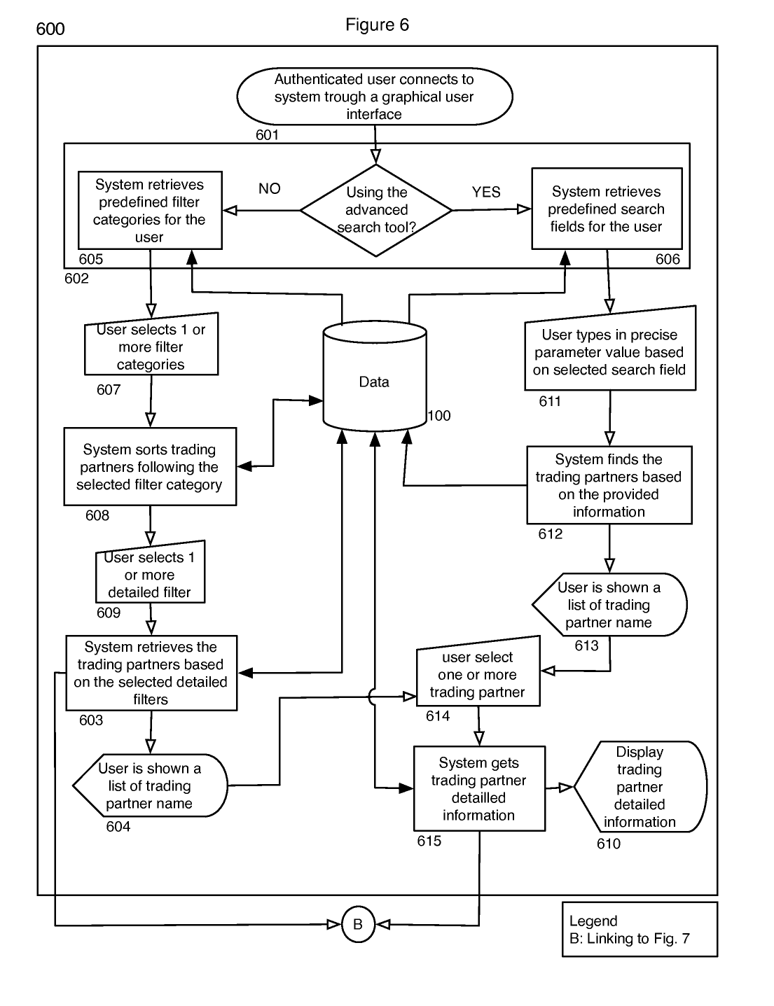

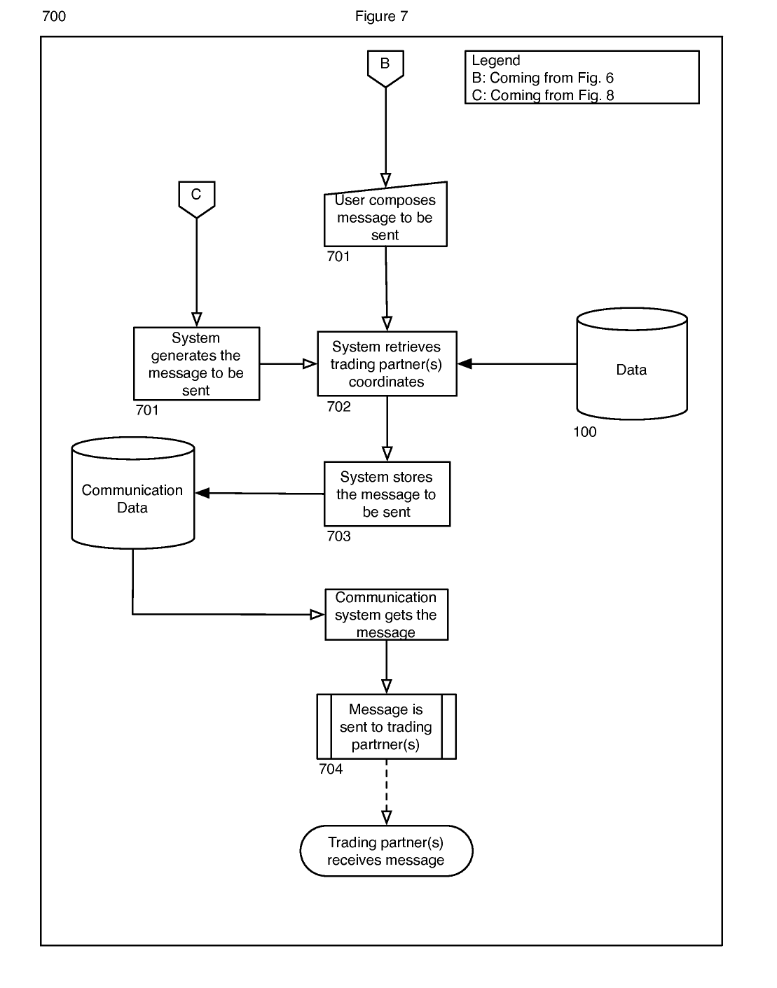

Now referring to FIGS. 6 and 7, a method for filtering trading partners within the authorized trading partners list of an EDI participant is presented 600. This method allows an EDI participant to search or filter one or more authorized trading partners associated with the EDI participant. The method for filtering trading partners may comprise steps to connect and authenticate with the system 601, to search trading partners using at least one filtering parameter, such as a category or a field 602, to fetch the matching trading partners based on the at least one filtering parameter 606, to retrieve and display information related to one or more selected trading partner 610, to send messages to one or more trading partner 700.

Similarly to step 501 presented in FIG. 5, the client device must connect and get authenticated to the system to be allowed to search for a trading partner 601. Once authenticated, a user may search for a trading partner using at least one filtering parameter 602. In the present embodiment, the system allows searching for a trading partner using at least one filtering category 605 or at least one predefined search field 606.

To search using filtering category 605, the user must select at least one category from a predefined list of categories 607. Following the selection of at least one category 607, the system displays the trading partners contained within the at least one selected category 608. The user may narrow the search by selecting and applying at least one detailed filter 609 to the displayed trading partners. On submission of the at least one detailed filter, the system fetches 603 and displays the trading partners of the EDI participant matching the at least one category and/or the at least one detail filter 604.

To search using predefined search fields 606, the user selects at least one predefined search field and inputs a search value to be associated with the predefined search field 611. On submission of the at least one predefined search field, the system fetches 612 and displays the trading partners of the EDI participant matching the at least one predefined search field 613.

In another embodiment, any other filtering process may be implemented in order to fetch and display the matching trading partners.

Following the fetching and displaying of the matching trading partners list, the user may select one or more trading partner from the matching trading partners list 614. Using the list of fetched matching trading partner, the user may also simultaneously communicate with at least one trading partner 603 and 615 using a method for communicating with trading partner herein described in FIG. 7 as B. On selection of one or more trading partner 614, the system fetches the complete information of a trading partner 615 and displays such information to the user through a graphical user interface 610. While consulting the trading partner information, the user may communicate with the one or more selected trading partner 614 by using a method for communicating with trading partner herein described in FIG. 7.

In another embodiment, a user may not be allowed to modify the information stored within the trading partner's EDI participant profile. However, a user may store information related to the trading partner within his own user account. Such stored information shall be private and only accessible by the user, hereafter referred to as a custom field. A custom field shall be only editable by the user and shall not be shared or displayed to the related trading partner or any other EDI participant registered in the system.

Now referring to FIG. 7, a method to communicate with at least one trading partner is presented. This method allows an EDI participant to send a message that may comprise text, images or video to any trading partner within the authorized trading partner list. The method to communicate with at least one trading partner may comprise the steps to input the message content 701, to fetch the trading partner coordinates within the registry data source 702, to create and store a message within a communication registry 703 and to send the message to the trading partner 704.

The step to input the message content 701 may allow a user to input text data and to attach any data file, such as binary file, image, video or sound.

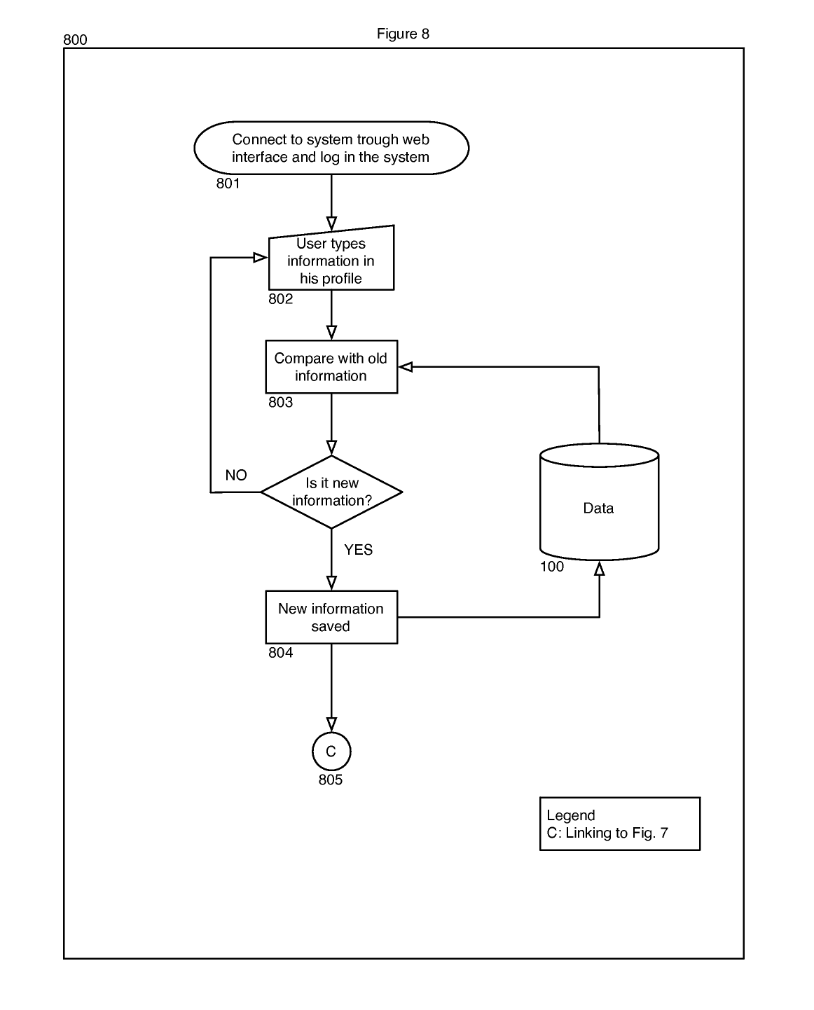

Now referring to FIG. 8, a method to update EDI participant information is presented. In the preferred embodiment, this method allows an EDI participant or any EDI participant user to update the EDI profile information through a graphical user interface of a client device. The method for updating EDI participant information may comprise steps to connect and authenticate with the system 801, to input or correct data related to the EDI profile 802, to update the EDI profile if the inputted data is novel 803 and 804 and to communicate the corrected information with one or more trading partners from the authorized trading partners list 805.

Similarly to step 601 presented in FIG. 6, the client device must connect and get authenticated to the system to be allowed to update the EDI participant information 801. Once authenticated, the user of the EDI participant may input new data or correct existing data of the EDI profile information 802, such as the supported transaction set, the coordinates of the technical contact person, or any field related to the EDI participant profile or the EDI identifier. On submission of the data, the system may validate the inputted information for errors. Once validated, the system compares the inputted information with the information already stored within the registry data storage 803. If the information is novel, the system corrects and stores the information within the registry data storage 804. Based on configuration parameters, the system sends a notification comprising the corrected EDI profile information to one or more trading partner 805. In the present FIG. 8, the anchor C links to the anchor C of FIG. 7 herein above described and presented as the notification method used for communicating with at least one trading partner.

In another embodiment, the system may communicate with any external or local system through any communication mean, such as API, web service or any protocol enabling the communication and interaction with an external system. The external or local system shall allow a user connected trough a graphical user interface to access the system through the communication mean.

The following examples of usage of the present system and plurality of methods for registering an EDI participant identifier and managing EDI trading partners are presented in order for the reader to gain a better understanding of the invention.

During an EDI exchange, an enterprise, which is an EDI participant, may receive a document from any of its trading partners. In the event where the enterprise is not able to validate the EDI identifier of the emitting trading partner, a representative of the enterprise may access the graphical interface of the herein described system through the

Internet and submit the unidentified EDI identifier to the search engine of the system. If the emitting trading partner is registered with the system, the enterprise may communicate with the emitting trading partner to report and communicate the unidentified document.

Also, a registered EDI participant willing to obtain information relating to a potential EDI partner may use the search engine to find the potential EDI partner data. The registered EDI participant will be able to consult the information if the potential EDI partner is registered with the system.

In the event where an enterprise is willing to start exchanging using EDI with at least one trading partner and has not registered an EDI identifier within the system, the enterprise must disclose or communicate an EDI identifier to all its trading partners. Having no EDI identifier, the enterprise must choose a unique EDI identifier. Using the search engine of the system, the enterprise shall be able to ensure or validate that the chosen EDI identifier is unique. In the event where the chosen EDI identifier is already assigned to another EDI participant, the system will provide at least one alternative available EDI identifier. Since the enterprise has no EDI profile account registered with the system, the user shall input the required information to create such an EDI profile account. On submission of the required information, the system will require the user to pay for the registration fees of the available EDI identifier. On reception of the payment, the system shall send a temporary password and a validation key. The user shall transmit the received validation key to the system in order to validate the account. On its next authentication to the system, the user shall change its password and accept the terms and conditions. During the same session with the system, the authenticated user shall complete the information related to the enterprise, the coordinates of the technical contact of the enterprise and any other additional information related to the registered identifier. On submission of this information, the system activates the newly registered EDI identifier.

An enterprise having at least one EDI identifier registered within the system may need to register an additional EDI identifier for testing purposes or for a new department of the enterprise. The enterprise having an EDI profile account and at least one user registered, one of these users has to search the EDI identifier to be registered in order to validate the availability of the identifier. If the identifier to be registered is available, the user may input the required information in order to register the EDI identifier, such information may comprise the industry standard version or revision to be used with the identifier, the qualifier of the identifier, the EDI communication method and the supported transaction types. Once the information is submitted to the system, the user shall proceed to the payment of the registration fees. On reception of the payment, the system will activate the EDI identifier which will be readily accessible to the other EDI participants.

Any registered EDI participant having at least one registered EDI identifier may add a trading partner to an authorized trading partner list. The authorized trading partner list allows an EDI participant to easily communicate with all the trading partners present within the list or to search for precise and detailed information relating to a trading partner, such information being kept secret between the two partners. The registered EDI participant must then log in to the system and search the trading partner within its trading partner list using different parameters such as the EDI identifier, the name of the partner or any other related information. If the trading partner exists within the system, the registered EDI participant may send an invitation to the found trading partner to request the sharing of the EDI information. On confirmation of the invited trading partner, the information is automatically shared between the two EDI participants. If the trading partner is not registered within the system, the invited trading participant shall need to create an account with the system before confirming the sharing of the EDI information. When the trading partner is added to the list, a user of both enterprises may add custom data about the related trading partner. This custom information remains accessible only by the inputting participant,

If, for instance, a registered EDI participant, having a plurality of trading partners in its trading partner list, wishes to retrieve the number of trading partner to which a specific EDI document may sent, a user of the registered EDI participant must add a filter of the category “Supported transaction” to the list. The system shall display only the supported transactions of the trading partners within the list. Then, a detailed filter having only the supported transaction types of the found trading partners shall be displayed to the user. If the supported transaction type to be found is not shown within the detailed filter, then the user is notified that no trading partner supports such transaction type. The EDI participant's user might also select a specific supported transaction. Consequently, the system shall display on the trading partners supporting the type of transaction.

By selecting one or more trading partners from the list, an EDI participant may communicate with the selected trading partners without having to find the coordinates of the trading partners. For instance, an EDI participant's user might notify all the EDI participant's trading partners contained in the trading partners list that the EDI participant payment system will be down for maintenance for the next two days or even send best wishes for Christmas Day. To communicate with the trading partners, the user must select the recipients, write the message to be sent and submit the message to the system which will automatically communicate the message to the selected trading partners.

Using the same communication method, the system will notify all the trading partners contained within the list when an EDI participant updates its EDI profile information. For instance, if the coordinates of the technical contact of an EDI participant are changed or if the EDI identifier is changed, all trading partners will be automatically notified of the change, reducing paperwork and simplifying the management of such information by the trading partners.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

What is claimed is:

1. A system for registering an EDI participant identifier and managing EDI trading partners, the system comprising:
a. at least one server;
i. configured to store at least one unique EDI identifier data;
ii. configured to store at least one EDI participant;
iii. configured to store at least one user account for the at least one EDI participant;
iv. configured to store at least one trading partner list for the at least one EDI participant;
v. configured to fetch EDI identifier matching to parameters data inputted by the at least one EDI participant;
b. at least one data storage service configured to persist the at least one EDI identifier data and the at least one EDI participant and related trading partner data;
c. at least one client input/output device connectable to the said server;
wherein the at least one server, the at least one data storage service and the at least one client device are connectable through a communication network.

2. The system for registering an EDI participant identifier according to claim 1, wherein the at least one unique EDI identifier data comprises at least one unique EDI identifier comprising a sequence of characters.

3. The system for registering an EDI participant identifier according to claim 1, wherein the at least one server is configured for the at least one EDI participant to communicate with at least one trading partner within the at least one EDI participant trading partner list.

4. The system for registering an EDI participant identifier according to claim 3, wherein the at least one server is configured for the at least one EDI participant to automatically communicate with at least one trading partner within the at least one EDI participant trading partner upon storing a modification of the EDI identifier data by the at least one EDI participant.

5. The system for registering an EDI participant identifier according to claim 1, wherein the at least one server is configured for the at least one EDI participant to filter the plurality of trading partners from the at least one EDI participant trading partner list using at least one filtering parameter, wherein the at least one filtering parameter comprises a filtering category selected from a predefined list of categories, a detailed filter, a predefined search field, or combination thereof

6. The system for registering an EDI participant identifier according to claim 1, wherein the at least one server is configured for the at least one EDI participant to filter the plurality of trading partners from the at least one EDI participant trading partner list using at least one filtering parameter.

7. The system for registering an EDI participant identifier according to claim 1, wherein the at least one server and the at least one storage service are installed on the same physical machine.

8. The system for registering an EDI participant identifier according to claim 1, wherein the at least one client input/output device comprises a graphical user interface and a network adapter allowing communication over the communication network.

9. The system for registering an EDI participant identifier according to claim 8, wherein the communication network is the Internet.

10. A method for searching an EDI identifier, the method comprising:
a. connecting to a system for registering a plurality of unique EDI identifiers;
b. inputting at least one identifier search parameter;
c. validating the at least one identifier search parameter;
d. displaying a list of at least one EDI identifier matching the at least one identifier search parameter;
e. selecting at least one EDI identifier from the list of at least one EDI identifier matching the at least one identifier search parameter;
f. displaying the selected unassigned identifier available for registration data.

11. A method for searching an EDI identifier according to claim 10, wherein the selected unassigned identifer data is partially or completely displayed based on a EDI participant status of an EDI participant.

12. A method for searching an EDI identifier according to claim 11, wherein the method further comprises :
a. displaying limited information related to the selected unassigned identifier available for registration data when the EDI participant has a “not authenticated” status;
b. displaying limited information related to the selected unassigned identifier available for registration data in addition to the limited information displayed to the EDI participant having the “not authenticated” status; when the EDI participant has “authenticated” status;
c. displaying complete information related to the selected unassigned identifier available for registration data when the EDI participant has “trading partner” status.

13. A method for registering an unassigned EDI identifier, the method comprising:
a. accessing a system for registering a plurality of unique EDI identifiers through an interface;
b. searching for an unassigned EDI identifier;
c. submitting a request to register the unassigned EDI identifier;
d. activating the newly assigned EDI identifier.

14. A method for registering an unassigned EDI identifier according to claim 13, wherein the method further comprising:
a. temporarily reserving the unassigned EDI identifier after searching for the identifier;
b. generating invoicing information after the request to register is submitted;
c. allowing payment for the registration.

15. A method for registering an unassigned EDI identifier according to claim 14, the method further comprising:
a. requesting the creation of a new user account in order to register the matching unassigned EDI identifier;
b. creating a user profile account;
c. reserving the newly assigned EDI identifier;
d. activating the user profile account;
e. said unauthenticated EDI participant inputting the new EDI participant related data;

16. A method for registering an unassigned EDI identifier for an unauthenticated EDI according to claim 15, wherein the method further comprising:
a. generating invoicing information after the creation for a user profile account;
b. allowing payment for the registration.

17. A method for adding a trading partner to an authorized trading partner, the method comprising:
a. connecting and getting authenticated with a system for registering a plurality of unique EDI identifiers;
b. searching for a trading partner;
c. sending an invitation notification to a trading partner or an external entity that is registered as an EDI participant to a system for registering a plurality of unique EDI identifiers;
d. confirming the relationship creation to the initiating EDI participant.

18. A method for adding a trading partner to an authorized trading partner according to claim 17, wherein the sending of an invitation notification to a trading partner further comprises with the following steps:
a. inviting an external entity that is using EDI as a communication method and that is not registered to a system for registering a plurality of unique EDI identifiers to register as an EDI participant within the system for registering a plurality of unique EDI identifiers;
b. accepting the invitation;
c. storing the relationship information within the data source.

19. A method for updating EDI participant information of an EDI participant, the method comprising:
a. connecting and getting authenticated with a system for registering a plurality of unique EDI identifiers;
b. inputting corrected data related to an EDI profile of the EDI participant;
c. updating the EDI profile when the inputted corrected data is novel;
d. communicating the corrected information with one or more trading partners from an authorized trading partners list of the EDI participant.

20. A method for updating EDI participant information according to claim 19, wherein the communication of the corrected information comprises:
a. creating a message including the corrected information;
b. fetching coordinates of at least one trading partner within at least one data storing service of a system for registering a plurality of unique EDI identifiers through an interface;
c. creating and storing a message within a communication registry;
d. sending the message to the at least one trading partner.
